(19) United States
(12) Patent Application Publication
(10) Pub. No.: US 2007/0253201 A1
(43) Pub. Date: Nov. 1, 2007

(54) Lighting fixture and method

(75) Inventors: Patrick Stephen Blincoe, Kirkville, NY (US); Clifford Randy Helmer, Fulton, NY (US)

Correspondence Address: HAYNES AND BOONE, LLP, 901 MAIN STREET, SUITE 3100, DALLAS, TX, 75202, US

(73) Assignee: Cooper Technologies Company, Houston, TX (US)

(21) Appl. No.: 11/412,387

(22) Filed: Apr. 27, 2006

(51) Int. Cl. F21V 29/00

(52) U.S. Cl. 362/294

(57) ABSTRACT

A lighting fixture and method such as, for example, an induction lighting fixture and method, is described.

### BACKGROUND

The present disclosure relates to luminaires or lighting fixtures such as, for example, induction luminaires or lighting fixtures.

### BRIEF DESCRIPTION OF THE DRAWINGS

FIG. 1 is a perspective view of a lighting fixture according to an embodiment, the lighting fixture including a housing and a cover coupled thereto.

FIG. 2 is an exploded view of the lighting fixture of FIG. 1, with the cover removed from view.

FIG. 3 is an exploded view of selected components of the lighting fixture of FIG. 1, which are depicted in FIG. 2.

FIG. 4A is a top plan view of the housing of the lighting fixture of FIG. 1.

FIG. 4B is a sectional view of the housing of FIG. 4A taken along line 4B-4B.

FIG. 4C is a bottom plan view of the housing of FIGS. 4A and 4B.

FIG. 5 is a perspective view of a mounting block according to an embodiment, which is depicted in FIG. 2.

FIG. 6 is a top plan view of the lighting fixture of FIG. 1, with the cover removed from view.

FIG. 7 is a sectional view of the lighting fixture of FIG. 6 taken along line 7-7.

FIG. 8A is a graph showing the experimental candlepower distribution of the lighting fixture of FIG. 1.

FIG. 8B is a table showing the experimental candelas and zonal lumens of the lighting fixture of FIG. 1.

FIG. 9 is a table showing the experimental coefficients of utilization for the lighting fixture of FIG. 1.

FIG. 10A is an experimental isofootcandle chart for the lighting fixture of FIG. 1.

FIG. 10B is a graph showing the isofootcandle lines for the lighting fixture of FIG. 1.

FIG. 11A is a sectional view of a lighting fixture according to another embodiment.

FIG. 11B is a partially exploded/partially unexploded view of the lighting fixture of FIG. 11A.

### DETAILED DESCRIPTION

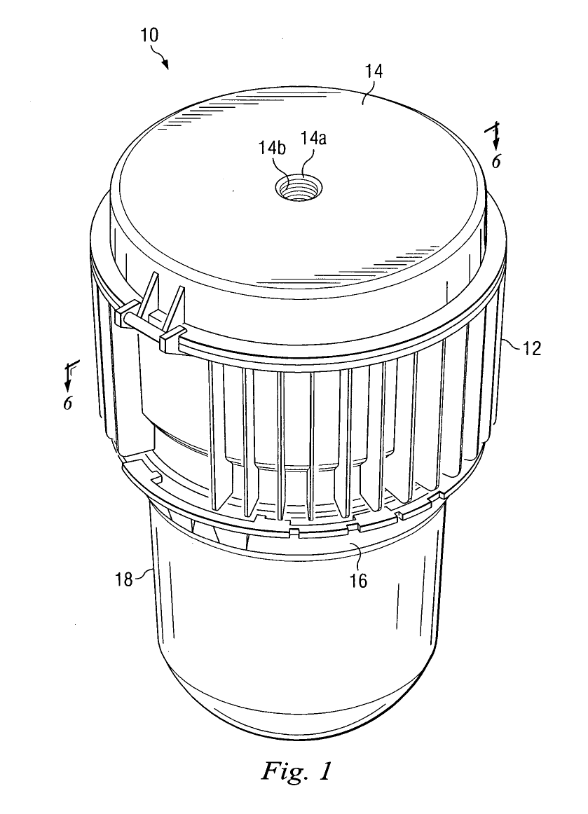

In an exemplary embodiment, as illustrated in FIG. 1, a luminaire or lighting fixture is generally referred to by the reference numeral 10 and includes a housing 12 and a cover 14 hingedly coupled thereto, the cover 14 including an opening 14a having an internal threaded connection 14b. A globe adapter 16 is coupled to the housing 12, and a globe 18 is coupled to the globe adapter 16.

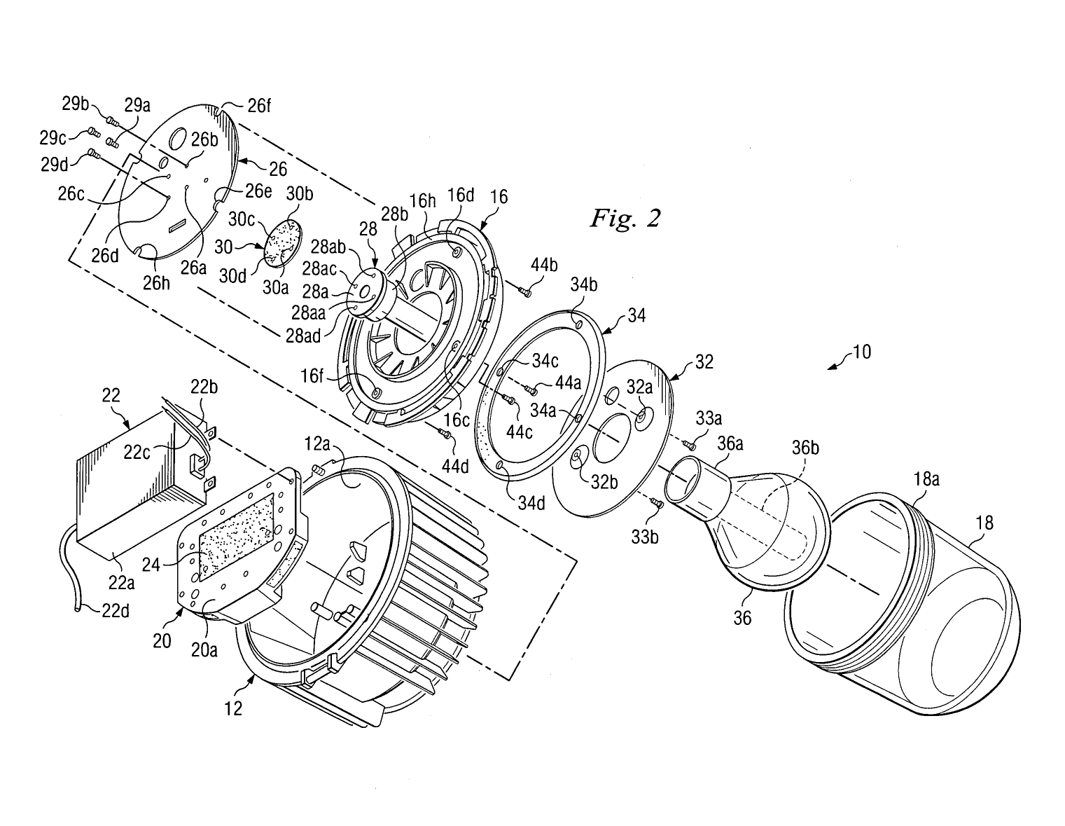

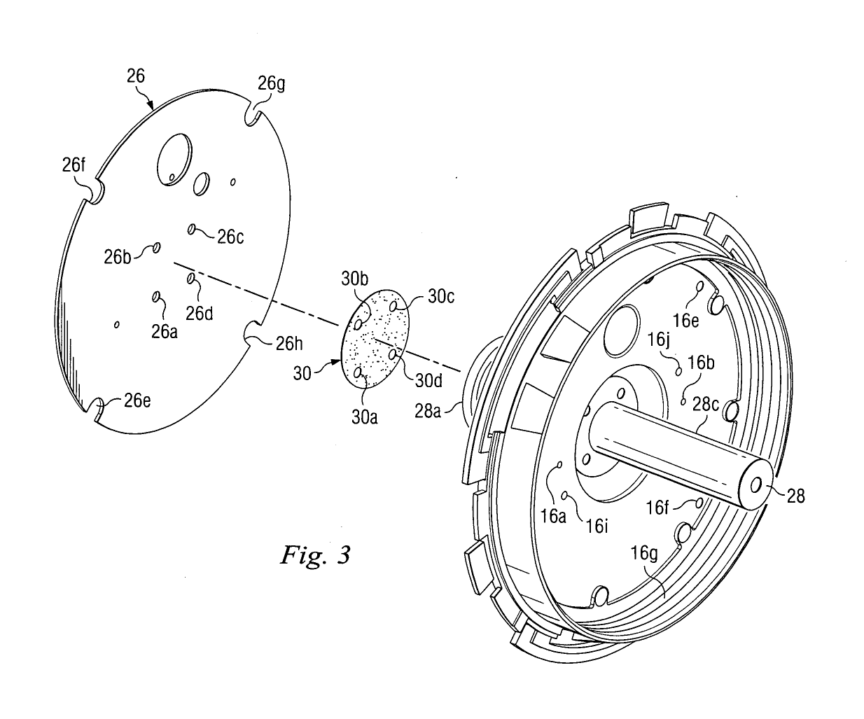

In an exemplary embodiment, as illustrated in FIGS. 2 and 3, the housing 12 defines a region 12a in which a mounting block 20 is disposed. The mounting block 20 is coupled to the housing 12 and defines a surface 20a. A high-frequency (HF) generator 22 is coupled to the mounting block 20, engaging the surface 20a, and includes a housing 22a, and wires 22b and 22c and a coaxial cable 22d extending into and out of the housing 22a, respectively. The HF generator 22 is adapted to receive line electrical power and supply output power in the form of a low voltage, high-frequency current signal such as, for example, a 2.65 Mhz current signal, in a manner and under conditions to be described. In several exemplary embodiments, the HF generator 22 comprises an oscillator enclosed within the housing 22a and to which the wires 22b and 22c, and the coaxial cable 22d, are electrically coupled.

A thermal pad 24 is disposed between the HF generator 22 and the surface 20a of the mounting block 20. The thermal pad 24 is adapted to provide a thermally-conductive interface between the housing 22a of the HF generator 22, and the surface 20a of the mounting block 20, under conditions to be described. In an exemplary embodiment, the thermal pad 24 is adapted to fill one or more air gaps between the housing 22a and the surface 20a, and comprises a material having a relatively high thermal conductivity. In an exemplary embodiment, the thermal pad 24 comprises a material having a thermal conductivity of about 6 W/mK. In an exemplary embodiment, the thermal pad 24 comprises a thickness of about 0.020 inches. In an exemplary embodiment, the thermal pad 24 comprises an operational temperature range from about −45 degrees C. to about 200 degrees C. In an exemplary embodiment, the thermal pad 24 comprises T-pli™ 220 gap filler, available from Thermagon, Inc. of Cleveland, Ohio., and/or a material comprising mechanical and physical properties that are substantially similar to the properties of T-pli™ 220 gap filler.

A power-coupler mounting plate 26 is engaged with the housing 12, and includes circumferentially-spaced through-holes 22a, 22b, 22c and 22d, and circumferentially-spaced notches 26e, 26f, 26g and 26h. In an exemplary embodiment, the power-coupler mounting plate 26 comprises a thermal conductivity of about 167 W/mK. In an exemplary embodiment, the power-coupler mounting plate 26 comprises an aluminum alloy. In an exemplary embodiment, the power-coupler mounting plate 26 comprises 6061 T6 aluminum alloy.

A power coupler 28 is coupled to the mounting plate 26, and includes a mounting flange 28a, a base 28b and a cylindrical portion 28c extending from the base 28b. The mounting flange 28a includes circumferentially-spaced holes 28aa, 28ab, 28ac and 28ad. Fasteners 29a, 29b, 29c and 29d extend through the through-holes 22a, 22b, 22c and 22d, respectively, and into the holes 28aa, 28ab, 28ac and 28ad, respectively, thereby coupling the power coupler 28 to the mounting plate 26. In an exemplary embodiment, each of the fasteners 29a, 29b, 29c and 29d comprises a screw adapted to be torqued to 18-22 lb-in.

The power coupler 28 is adapted to transfer energy from the HF generator 22 in a manner and under conditions to be described. In an exemplary embodiment, the cylindrical portion 28c comprises an antenna comprising a coil and a ferrite core, which together are adapted to produce a high-frequency magnetic field such as, for example, a 2.65 Mhz magnetic field.

A thermal pad 30 is disposed between the mounting plate 26 and the mounting flange 28a of the power coupler 28, and is adapted to provide a thermally-conductive interface between the mounting plate 26 and the mounting flange 28a, under conditions to be described. The thermal pad 30 includes circumferentially-spaced through-holes 30a, 30b, 30c and 30d, through which the fasteners 29a, 29b, 29c and 29d extend, respectively. In an exemplary embodiment, the thermal pad 30 is adapted to fill one or more air gaps between the mounting plate 26 and the mounting flange 28a. In several exemplary embodiments, the thermal pad 30 comprises a thickness of about 0.020 inches. In several exemplary embodiments, the thermal pad 30 comprises a material that is substantially similar to the material of which the thermal pad 24 is comprised, as described above.

An inner reflector 32 is coupled to the globe adapter 16 via fasteners 33a and 33b, which extend through respective through-holes 32a and 32b of the reflector 32 and respective through-holes 16a and 16b of the globe adapter 16 axially aligned therewith. A globe gasket 34 is disposed between the globe adapter 16 and the inner reflector 32, and includes through-holes 34a, 34b, 34c and 34d. The globe adapter 16 includes through-holes 16c, 16d, 16e and 16f, and an internal threaded connection 16g, with which an external threaded connection 18a of the globe 18 is threadably engaged. The globe adapter 16 further includes a circumferentially-extending channel in which a globe adapter gasket 16h is disposed, and through-holes 16i and 16j through which respective fasteners (not shown) extend to couple the globe adapter 16 to the mounting plate 26.

A lamp cap 36a of a lamp 36 is coupled to the base 28b of the power coupler 28 so that the cylindrical portion 28c extends into a stem 36b of the lamp 36. In an exemplary embodiment, the lamp 36 comprises a glass bulb containing an amalgam or mercury metal mixture and an inert buffer gas. In an exemplary embodiment, the inside wall of the lamp 36 is coated with a fluorescent phosphor mixture such as, for example, 3-line Super/80 phosphorous used in TL-D, TL-5 and/or PL type lamps. In an exemplary embodiment, the HF generator 22, the power coupler 28 and the lamp 36 together at least partially define an induction lamp system so that the lighting fixture 10 is considered to be an induction luminaire or an induction lighting fixture. In an exemplary embodiment, the induction lamp system at least partially defined by the HF generator 22, the power coupler 28 and the lamp 36 comprises a 165-watt induction lamp system. In an exemplary embodiment, the induction lamp system at least partially defined by the HF generator 22, the power coupler 28 and the lamp 36 comprises one or more components of a Philips QL Induction Lamp System, available from Philips Lighting, B.V. In several exemplary embodiments, instead of, or in addition to an induction lamp system, the lamp 36 may comprise one or more high-intensity-discharge (HID) lamps such as, for example, a high pressure sodium lamp, a pulse start metal halide lamp, a metal halide lamp, and/or any combination thereof, and/or may comprise one or more incandescent or fluorescent lamps.

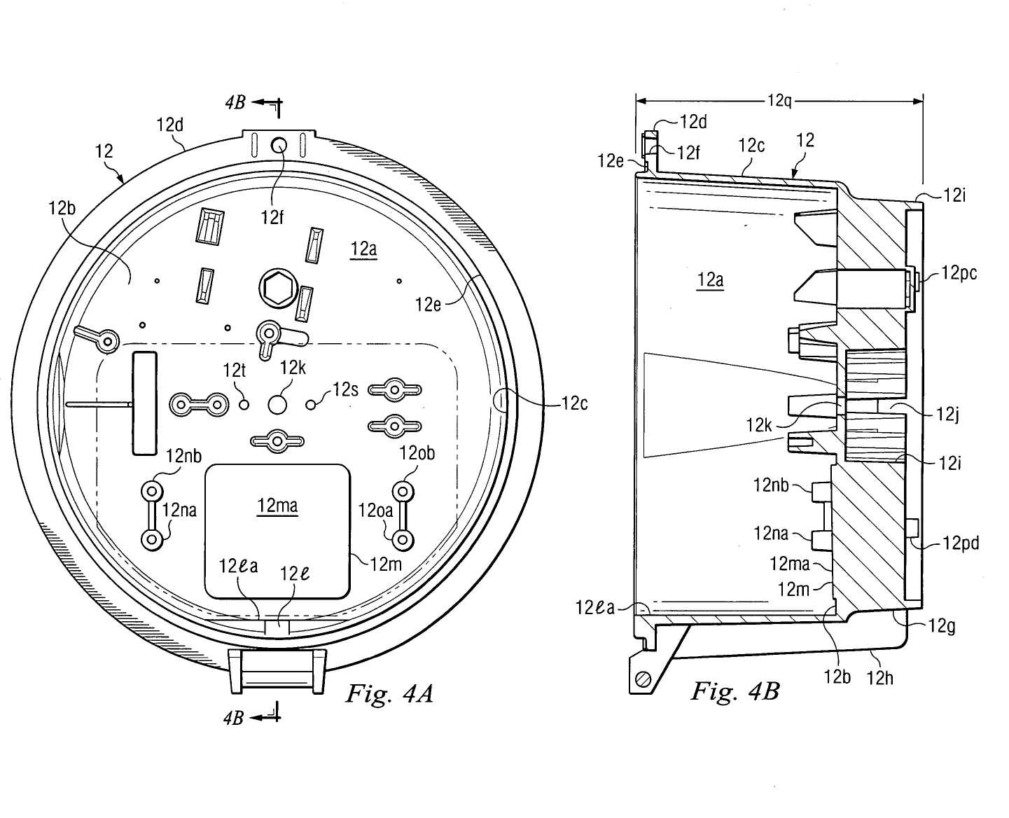

In an exemplary embodiment, as illustrated in FIGS. 4A, 4B and 4C, the housing 12 further includes a generally disk-shaped base wall 12b and a circumferentially-extending wall 12c that extends from the base wall 12b. As shown in FIG. 4B, the wall 12c includes a draft, extending from the base wall 12b at a relatively small angle from the horizontal. The region 12a is generally defined by the base wall 12b and the wall 12c. A lip 12d extends radially outward from the wall 12c and a circumferentially-extending channel 12e is formed in the lip 12d. An opening 12f extends through the lip 12d. A circumferentially-extending wall 12g extends from the base wall 12b in a direction generally opposing the direction of extension of the wall 12c. A plurality of fins 12h extends radially outward from the wall 12c, the base wall 12b and the wall 12g. A plurality of fins 12i extend axially from the base wall 12b, and extend radially inward from the wall 12g. A generally cylindrically-shaped region 12j is generally defined by the distal ends of the fins in the plurality of fins 12i that generally oppose the inside surface of the wall 12g. A center through-hole 12k extends through the base wall 12b.

An insert feature 121 extends from the inside surface of the wall 12c and along the axial length of the region 12a, defining a generally flat surface 121a that is about parallel to the horizontal, as viewed in FIG. 4B. A generally square-shaped relief portion 12m extends from the base wall 12b and into the region 12a, defining a generally flat surface 12ma. Pairs of aligned bosses 12na and 12nb, and 12oa and 12ob, having respective openings formed therein, extend upwardly from the base wall 12b, and are symmetrically spaced from the relief portion 12m, as viewed in FIG. 4A. Bosses 12pa, 12pb, 12pc and 12pd extend downwardly from the base wall 12b, and have respective openings formed therein. In an exemplary embodiment, the housing 12 is composed of a copper-free, die-cast aluminum alloy. The housing 12 defines an overall height 12q and an outer diameter 12r. In an exemplary embodiment, the overall height 12q is about six (6) inches, and the outer diameter 12r is about eleven (11) inches. The housing 12 further includes through-holes 12s and 12t.

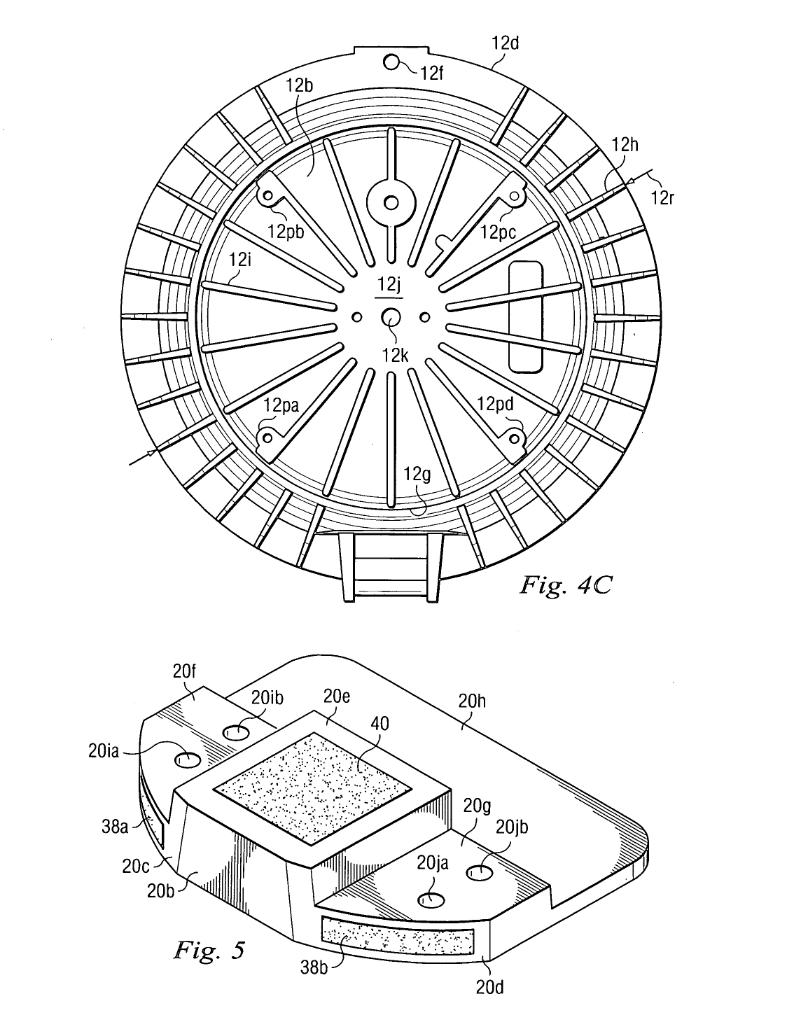

In an exemplary embodiment, as illustrated in FIG. 5, the mounting block 20 further defines a generally vertically-extending surface 20b, a pair of curved surfaces 20c and 20d, which are arranged symmetrically on either side of the surface 20b, a generally horizontally-extending surface 20e, generally horizontally-extending surfaces 20f and 20g, which are offset from the surface 20e, and a generally horizontally-extending surface 20h, which is offset from the surfaces 20f and 20g. Counterbores 20ia and 20ib extend through the mounting block 20, with the respective increased-diameter portions of the counterbores 20ia and 20ib being formed in the surface 20a and the respective reduced-diameter portions of the counterbores 20ia and 20ib being formed in the surface 20f. Similarly, counterbores 20ja and 20jb extend through the mounting block 20, with the respective increased-diameter portions of the counterbores 20ja and 20jb being formed in the surface 20a and the respective reduced-diameter portions being formed in the surface 20g.

Generally rectangular-shaped thermal pads 38a and 38b are adapted to engage the surfaces 20c and 20d, respectively, of the mounting block 20, and are adapted to provide thermally-conductive interfaces between the inside surface of the wall 12c of the housing 12 and the surfaces 20c and 20d, respectively, of the mounting block 20, under conditions to be described. In an exemplary embodiment, the thermal pads 38a and 38b are adapted to fill one or more air gaps between the inside surface of the wall 12c of the housing 12 and the surfaces 20c and 20d, respectively, under conditions to be described. In several exemplary embodiments, the thermal pads 38a and 38b may each comprise a thickness of about 0.020 inches. In several exemplary embodiments, the thermal pads 38a and 38b may each comprise a material that is substantially similar to the material of which the thermal pad 24 is comprised, as described above. A generally square-shaped thermal pad 40 is adapted to engage the surface 20e of the mounting block 20, and is adapted to provide a thermally-conductive interface between the surface 20e and the surface 12ma of the housing 12. In an exemplary embodiment, the thermal pad 40 is adapted to fill one or more air gaps between the surface 20e and the surface 12ma of the housing 12, under conditions to be described. In several exemplary embodiments, the thermal pad 40 comprises a thickness of about 0.020 inches. In several exemplary embodiments, the thermal pad 40 comprises a material that is substantially similar to the material of which the thermal pad 24 is comprised, as described above.

In an exemplary embodiment, as illustrated in FIGS. 2, 6 and 7, the mounting block 20 is coupled to the housing 12 via fasteners that extend through the counterbores 20ia, 20ib, 20ja and 20jb and into the openings of the bosses 12oa, 12ob, 12na and 12nb, respectively. As a result, the thermal pads 38a and 38b are disposed between and engage the inside surface of the wall 12c of the housing 12 and the surfaces 20c and 20d, respectively, of the mounting block 20, thereby filling one or more of any air gaps therebetween. In several exemplary embodiments, the thermal pads 38a and 38b may be engaged with either the inside surface of the wall 12c or the surfaces 20c and 20d, respectively, prior to the assembly of the lighting fixture 10, or may be disposed therebetween during the assembly of the lighting fixture 10.

Moreover, the thermal pad 40 is disposed between and engages the surface 12ma of the housing 12 and the surface 20e of the mounting block 20, thereby filling one or more of any air gaps therebetween. In several exemplary embodiments, the thermal pad 40 may be engaged with either the surface 12ma or the surface 20e prior to the assembly of the lighting fixture 10, or may be disposed therebetween during the assembly of the lighting fixture 10. Also, the surface 20b of the mounting block 20 engages or is proximate the surface 121a of the housing 12.

Fasteners 42a, 42b, 42c and 42d extend through respective tabs of the HF generator 22 and into the mounting block 20, thereby coupling the HF generator 22 to the mounting block 20. As a result, the thermal pad 24 is disposed between and engages the housing 22a of the HF generator 22, and the surface 20a of the mounting block 20, thereby filling one or more of any air gaps therebetween.

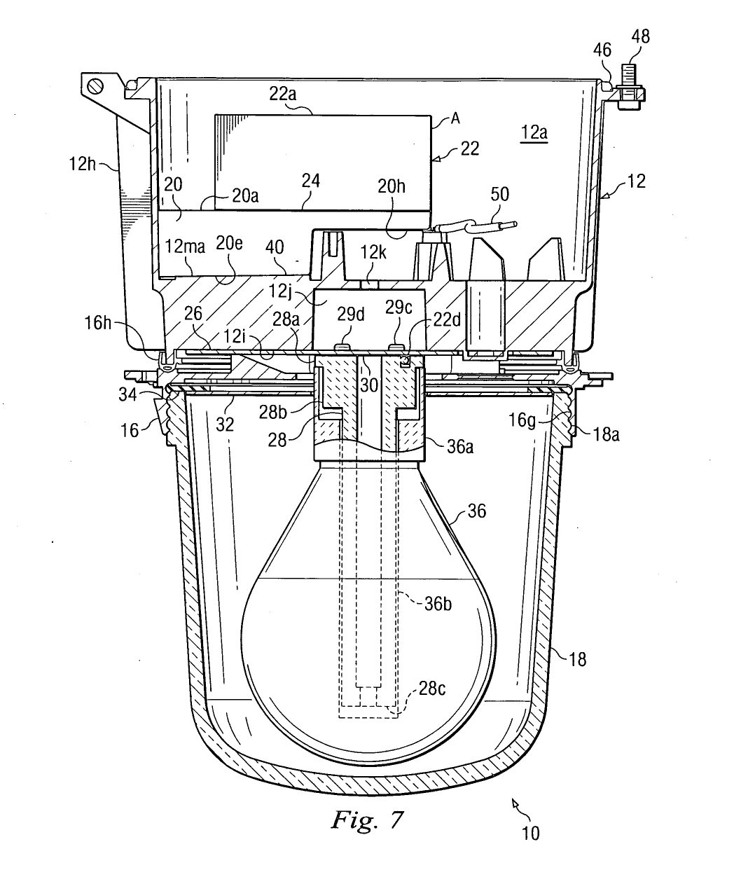

Fasteners 44a, 44b, 44c and 44d extend through the holes 16c, 16d, 16e and 16f, respectively, of the globe adapter 16, the notches 26e, 26f, 26g and 26h, respectively, of the mounting plate 26, and into the openings in the bosses 12pa, 12pb, 12pc and 12pd, respectively, of the housing 12, thereby coupling the globe adapter 16 to the housing 12, causing the mounting plate 26 to engage the fins 12i of the housing 12, causing the globe adapter gasket 16h to sealingly engage the globe adapter 16 and the distal end of the wall 12g of the housing 12, and causing the globe gasket 34 to sealingly engage the globe adapter 16 and the globe 18, as shown in FIG. 7.

When the lighting fixture 10 is in an installed condition, a gasket 46 is disposed in the channel 12e of the housing 12, and the cover 14 is closed and locked to the housing 12 via a fastener 48, thereby causing the gasket 46 to sealingly engage the cover 14. In an exemplary embodiment, the lighting fixture 10 is mounted to a support bracket or structure such as, for example, a pendant, which is coupled to an overhead support structure such as a ceiling; a wall bracket, which is mounted to a vertically-extending support structure such as a wall; a stanchion, which is mounted to a horizontally-extending support structure such as a floor; a ceiling mounting bracket, which is mounted to an overhead support structure such as a ceiling; and/or any combination thereof. To mount this support bracket or structure to the lighting fixture 10, the support bracket or structure may include an external threaded connection that engages the internal threaded connection 14b of the cover 14.

Moreover, the wires 22b and 22c of the HF generator 22 are electrically coupled to a source of electrical power, thereby electrically coupling the HF generator 22 to the source of electrical power. In an exemplary embodiment, the HF generator 22 may be electrically coupled to a source of electrical power that is positioned outside of the housing 12, and the wires 22b and 22c may extend through the opening 14a of the cover 14. A ground wire 50 is coupled to a boss 12u of the housing 12 via a fastener 52, and is electrically coupled to ground. In an exemplary embodiment, the ground wire 50 may extend through the opening 14a of the cover 14. The coaxial cable 22d of the HF generator 22 extends within the region 12a of the housing 12, underneath the surface 20h of the mounting block 20, through the through-hole 12k and into the region 12j of the housing 12, and is electrically coupled to the above-described antenna of the cylindrical portion 28c of the power coupler 28.

In several exemplary embodiments, due to the use of the above-described components of the lighting fixture 10, including, for example, the gaskets 16h, 34 and 46, the lighting fixture 10 may be installed in locations generally classified as Class I, Division 2, Groups A, B, C and/or D locations; locations generally classified as Class I, Zone 2, Groups IIA, IIB and/or IIC locations; wet locations; and/or marine locations.

In operation, electrical power is supplied to the HF generator 22 via the wires 22b and 22c. In response, the HF generator 22 outputs power in the form of a low voltage, high-frequency current signal such as, for example, a 2.65 Mhz current signal, which is supplied to the antenna of the cylindrical portion 28c of the power coupler 28. As a result, the antenna of the cylindrical portion 28c of the power coupler 28 creates an electromagnetic field, thereby activating ions in the mercury metal mixture to create ultraviolet (UV) light. The above-described fluorescent phosphor mixture on the inside surface of the lamp 36 converts the generated UV light into visible light. As a result, the lamp 36 provides light to the environment surrounding the lighting fixture 10. In an exemplary embodiment, the power consumption of the lighting fixture 10 may be, for example, about 165 watts. In an exemplary embodiment, the power consumption of the lighting fixture 10 may be, for example, about 230 VAC at about 700 mA, or about 161.00 watts.

During the operation of the lighting fixture 10, the power coupler 28 dissipates power in the form of heat. The majority of this heat flows from the power coupler 28 to the environment surrounding the lighting fixture 10 via several thermal paths. One such thermal path first includes conductive heat transfer from the mounting flange 28a of the power coupler 28 to the power-coupler mounting plate 26. The thermal pad 30 provides a thermally conductive interface between the mounting flange 28a and the mounting plate 26, promoting conductive heat transfer therebetween. The heat then conducts and spreads across the mounting plate 26, and further flows into the fins 12i and the base wall 12b of the housing 12 via conductive heat transfer. The heat then conducts and spreads through the housing 12, and then flows into the environment surrounding the lighting fixture 10 via convective heat transfer from the housing 12, including from the fins 12h, the wall 12c, the wall 12g and/or any combination thereof.

Moreover, during the operation of the lighting fixture 10, the HF generator 22 also dissipates power in the form of heat. The majority of this heat flows from the HF generator 22 to the environment surrounding the lighting fixture 10 via several thermal paths. One such thermal path includes conductive heat transfer from the HF generator 22 to the surface 20a of the mounting block 20. The thermal pad 24 provides a thermally-conductive interface between the HF generator 22 and the surface 20a, promoting conductive heat transfer therebetween. The heat then conducts and spreads through the mounting block 20. A portion of the heat flows from the surfaces 20c and 20d of the mounting block 20 to the inside surface of the wall 12c of the housing 12 via conductive heat transfer. The thermal pads 38a and 38b provide thermally-conductive interfaces between the mounting block 20 and the wall 12c of the housing 12, promoting conductive heat transfer therebetween. Another portion of the heat within the mounting block 20 flows from the surface 20e of the mounting block 20 to the surface 12ma of the housing 12 via conductive heat transfer. The thermal pad 40 provides a thermally-conductive interface between the mounting block 20 and the surface 12ma of the housing 12, promoting conductive heat transfer therebetween. After flowing into the housing 12, the heat then conducts and spreads through the housing 12, and then flows into the environment surrounding the lighting fixture 10 via convective heat transfer from the housing 12, including from the fins 12h, the wall 12c, the wall 12g and/or any combination thereof.

As a result of the above-described heat-transfer mechanisms, heat flow and thermal paths, any heat flow from the power coupler 28 to the HF generator 22 is appreciably reduced, thereby minimizing any temperature increase in the HF generator 22 due to the power dissipation of the power coupler 28.

In several exemplary embodiments, in addition to, or instead of the thermal paths described above, any heat that is generated by the HF generator 22 and/or the power coupler 28 may flow through one or more of the above-described components of the lighting fixture 10 using a wide variety of thermal paths and/or heat transfer modes, including conductive heat transfer, convective heat transfer, radiative heat transfer and/or any combination thereof. Moreover, in several exemplary embodiments, in addition to, or instead of the thermal paths described above, heat may flow into any support structure to which the lighting fixture 10 is coupled.

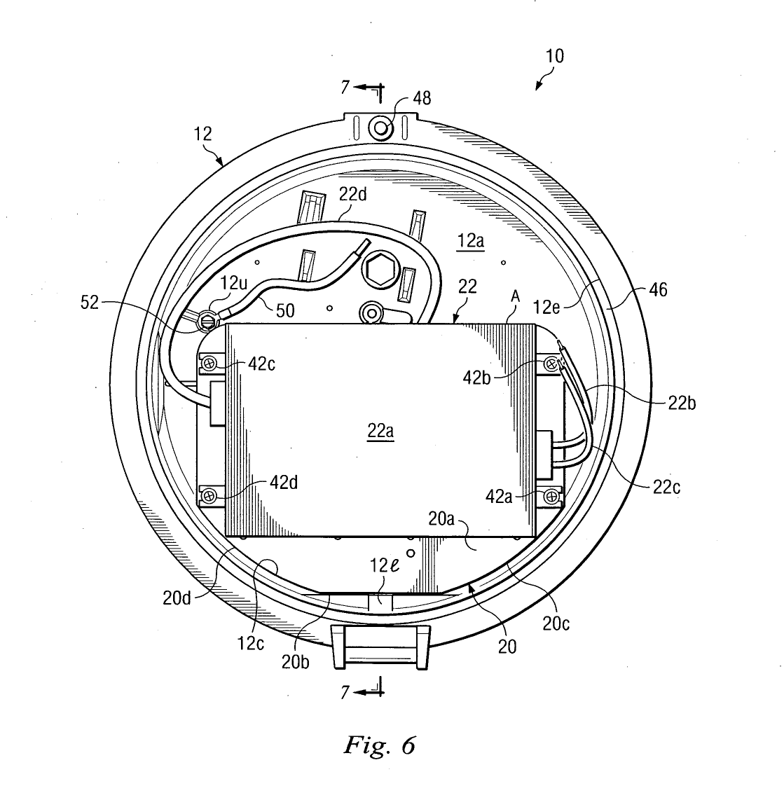

Referring to FIGS. 6, 7, 8A, 8B, 9, 10A and 10B, experimental testing of the lighting fixture 10 was conducted, with the lighting fixture 10 operating in the above-described manner during the experimental testing.

During at least a portion of the experimental testing, experimental temperature data was recorded, during which the power consumption of the lighting fixture 10 was at least about 165+/−10% watts, that is, at least about 148.5 watts. The experimental temperature of the HF generator 22 was measured using a thermocouple at a point A on the housing 22a of the HF generator 22, as shown in FIGS. 6 and 7. The experimental temperature of the HF generator 22 was recorded at an ambient air temperature of 40 degrees C., with ambient air temperature referring to the temperature of the air in the environment surrounding the lighting fixture 10. During the experimental testing, the experimental temperature of the HF generator 22 was measured and recorded with the lighting fixture 10 mounted to the ceiling, and with the lighting fixture 10 mounted to a stanchion. During the experimental testing, the experimental temperature of the HF generator 22 was measured and recorded using the globe 18, and using a refractor in place of the globe 18.

Under any combination of the above-described experimental conditions, the experimental temperature of the HF generator 22 was less than or equal to about 65+/−10% degrees C., that is, less than or equal to about 71.5 degrees C., at an ambient air temperature of about 40 degrees C. Thus, the experimental temperature rise above ambient of the HF generator 22, that is, the difference in temperature between the experimental temperature of the HF generator 22 and the ambient air temperature, was less than or equal to about 31.5 degrees C. This was an unexpected result.

In view of the above-described experimental temperature results, safe end of life of the HF generator 22 is highly likely because the experimental temperatures of the HF generator 22 was always less than about 82 degrees C., the temperature above which safe end of life of the HF generator 22 cannot be assured.

Using the U.S. method, the above-described experimental temperature results show that the lamp 36 of the lighting fixture 10 has an average lamp life of about 100,000 hours. Under the U.S. method, average life is determined by placing 100 lamps in a room. The time it takes for the first 50 lamps to burn out (50% survival) is the average life. Lamp life is affected by temperature. For the lighting fixture 10, the lamp 36 has an average life of about 100,000 hours with a 50% failure rate if the temperature at the point A on the housing 22a of the HF generator 22 is less than or equal to about 65+/−10% degrees C., that is, less than or equal to about 71.5 degrees C., during the operation of the lighting fixture 10. Determining that the lamp 36 of the lighting fixture 10 has an average lamp life of about 100,000 hours using the U.S. method was an unexpected result.

Using the European method, the above-described experimental temperature results show that the lamp 36 of the lighting fixture 10 has an average life of about 60,000 hours. Under the European method, average life is determined by placing 100 lamps in a room. The time it takes for the first 10 lamps to burn out (10% survival) is the average life. As noted above, lamp life is affected by temperature. For the lighting fixture 10, the lamp 36 has an average life of about 60,000 hours with a 10% failure rate if the temperature at the point A on the housing 22a of the HF generator 22 is less than or equal to about 65+/−10% degrees C., that is, less than or equal to about 71.5 degrees C., during the operation of the lighting fixture 10. Determining that the lamp 36 of the lighting fixture 10 has an average lamp life of about 60,000 hours using the European method was an unexpected result.

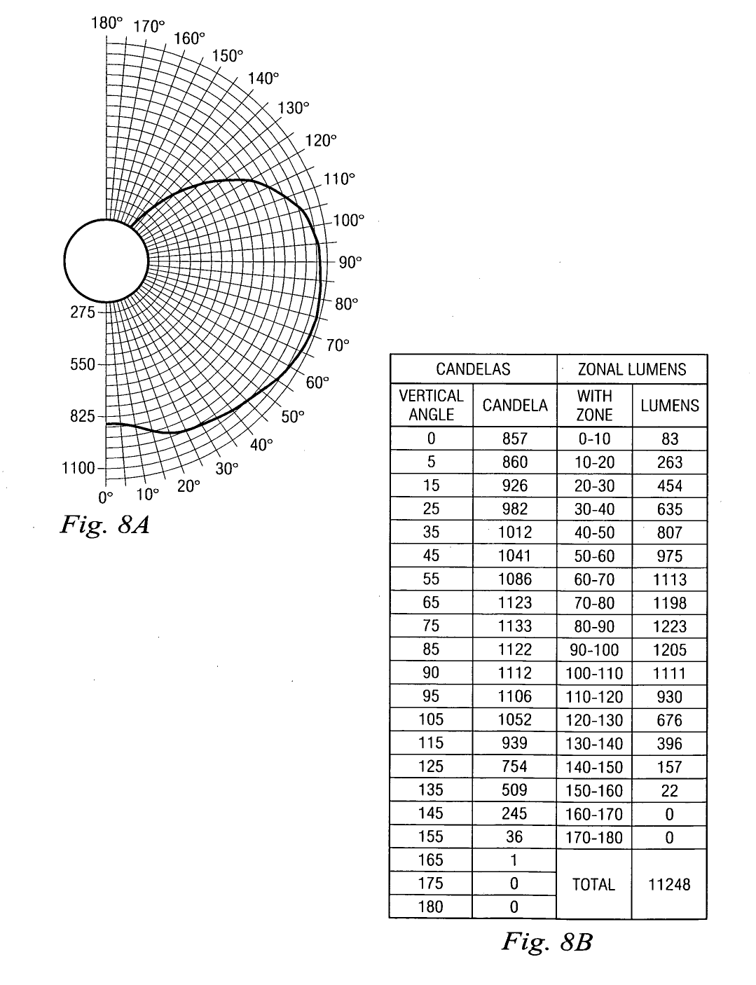

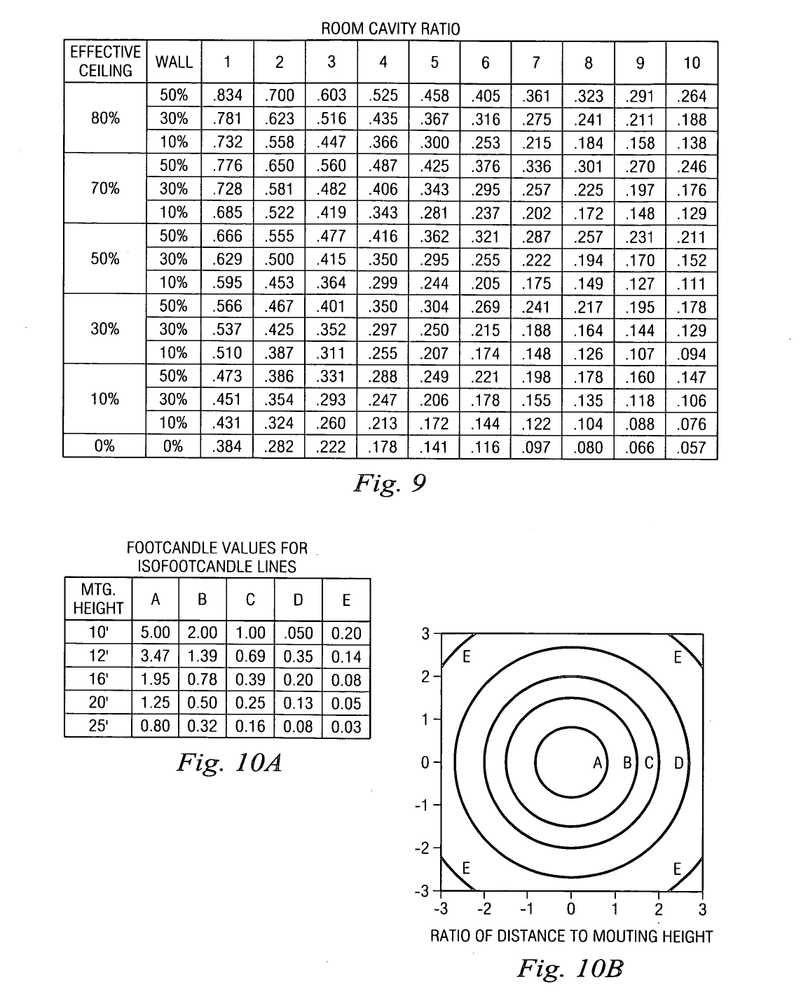

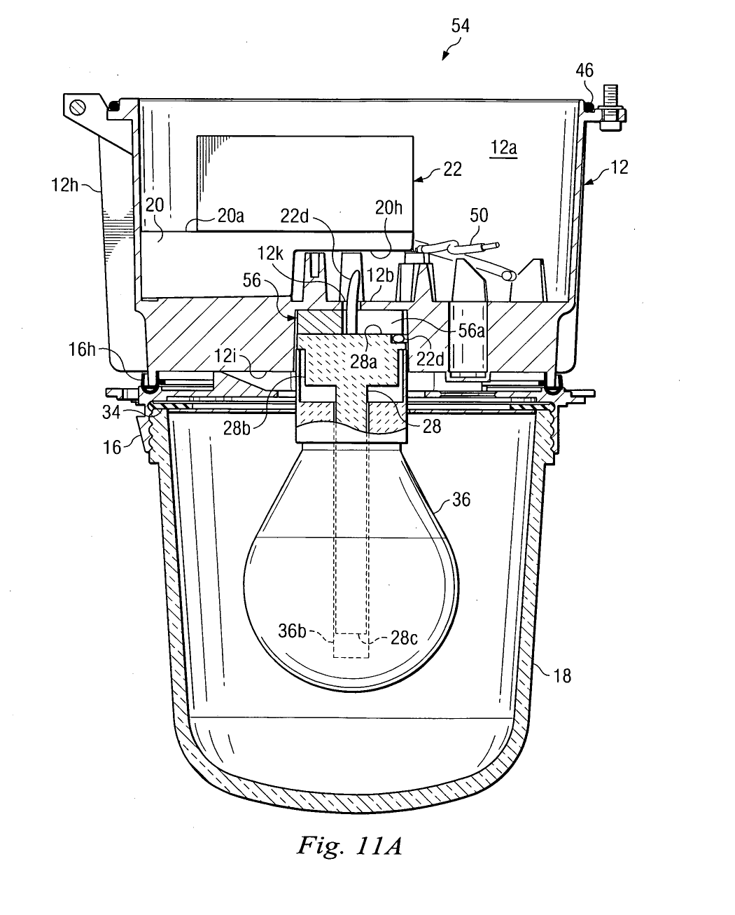

During the experimental testing, experimental photometric data was recorded, during which the power consumption of the lighting fixture 10 was at least about 165+/−10% watts, that is, at least about 148.5 watts. Moreover, the lamp 36 provided 12,000 initial lumens and 9,600 mean lumens, with mean lumens referring to the average quantity of light output over the life of the lamp. The initial efficacy of the lamp 36 was 72 lumens/watt and the mean efficacy was 58 lumens/watt. For the lighting fixture 10, the experimental candlepower distribution in candelas is shown in FIG. 8A, and the experimental candelas and zonal lumens are shown in FIG. 8B. Experimental coefficients of utilization, having an effective floor cavity reflectance of 20%, are shown in FIG. 9. An experimental isofootcandle chart is shown in FIG. 10A, indicating experimental illuminance in footcandles at ground level for the isofootcandle lines plotted in FIG. 10B, which indicates the ratio of distance to mounting height.

In comparison to the lighting fixture 10, which uses a 165-watt induction lighting system, a conventional lighting fixture using a conventional 175-watt metal halide pulse start lamp provides 13,500 initial lumens and 8,775 mean lumens, and has an average life of about 15,000 hours using the U.S. method. As a result, it is clear that the lighting fixture 10 provides about as much light as a conventional lighting fixture using a conventional 175-watt metal halide pulse start lamp but lasts about seven (7) times longer. The relatively high average life of the lamp 36 of the lighting fixture 10 significantly lowers the overall cost of maintaining and/or replacing the lighting fixture 10, in terms of both parts and labor. For example, and on average using the U.S. method, if the lighting fixture 10 provides 100 hours of illumination per week, over nineteen years will pass before the lighting fixture 10 has to be replaced.

In view of the experimental testing results, the capability of the lighting fixture 10 to consume about 165+/−10% watts of power, to provide about 12,000 initial lumens and 9,600 mean lumens, and to have an average life of about 100,000 hours using the U.S. method, while housing the HF generator 22 in a housing as compact and small as the housing 12-the overall height 12q of which is about six (6) inches and the outer diameter 12r of which is about eleven (11) inches-was an unexpected result.

In an exemplary experimental embodiment, a vapor-tight seal was installed in the opening 14a of the cover 14 and the lighting fixture 10 was operated in the above-described manner, consuming about 165+/−10% watts of power. Due to the vapor-tight seal in the opening 14a, gases were generally prevented from flowing between the region 12a of the housing 12 and the environment surrounding the lighting fixture 10. Experimental temperature testing was conducted, during which the outside surface temperature of the globe 18 was measured and recorded at an ambient air temperature of about 40 degrees C. At an ambient air temperature of about 40 degrees C., the experimental outside surface temperature of the globe 18 was less than or equal to about 100 degrees C. Thus, the experimental temperature rise above ambient of the outside surface of the globe 18, that is, the difference in temperature between the experimental temperature of the outside surface of the globe 18 and the ambient air temperature, was less than or equal to about 60 degrees C. This was an unexpected result. The above-described experimental temperature test results show that the lighting fixture 10 delivers a T-rating of T5, pursuant to publication 79-0 of the International Electro-Technical Commission (IEC). In view of the experimental test results, the capability of the lighting fixture 10 to provide 12,000 initial lumens and a T-rating of T5 was an unexpected result.

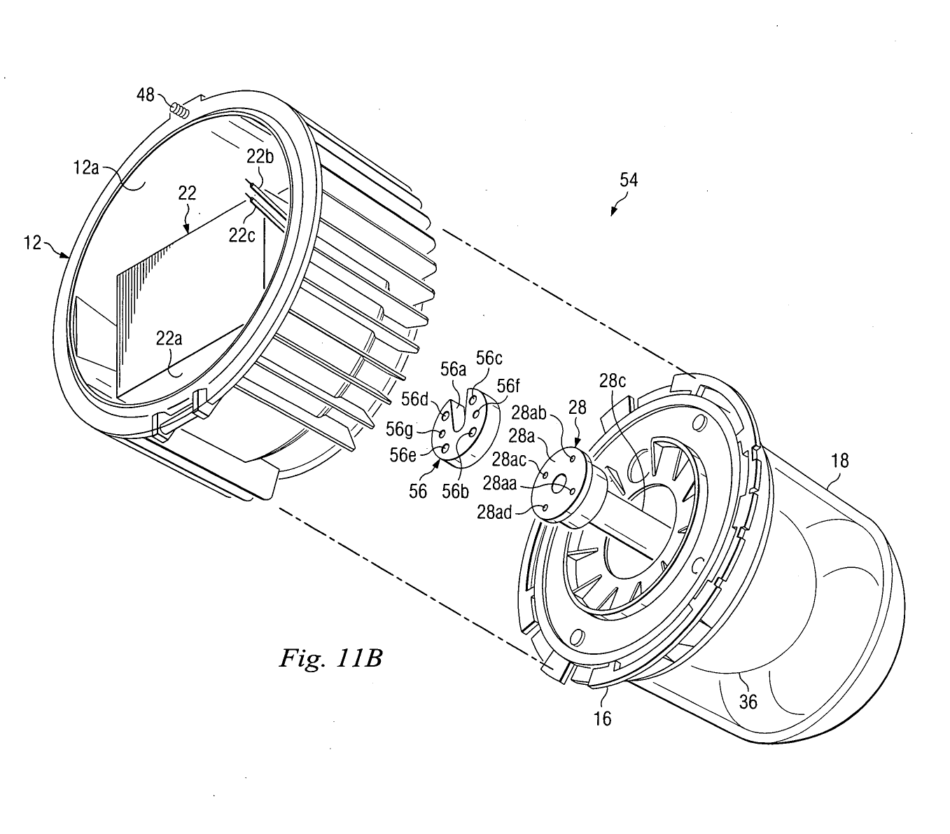

In an exemplary embodiment, as illustrated in FIGS. 11A and 11B, a lighting fixture is referred to in general by the reference numeral 54, and includes several parts of the lighting fixture 10 of FIGS. 1 through 10B, which are given the same reference numerals.

As shown in FIGS. 11A and 11B, the lighting fixture 54 includes a power-coupler mounting block 56, which includes a notch 56a and is coupled to the mounting flange 28a of the power coupler 28 via a plurality of fasteners (not shown) that extend through counterbores 56b, 56c, 56d and 56e of the power-coupler mounting block 56 and into the holes 28aa, 28ab, 28ac and 28ad, respectively, of the power coupler 28. In an exemplary embodiment, the power-coupler mounting block 56 comprises a thermal conductivity of about 167 W/mK. In an exemplary embodiment, the power-coupler mounting block 56 comprises an aluminum alloy. In an exemplary embodiment, the power-coupler mounting block comprises 6061 T6 aluminum alloy. The power-coupler mounting block 56 is coupled to the wall 12b of the housing 12 via a pair of fasteners (not shown) that extend through the holes 12s and 12t of the housing 12 and into holes 56f and 56g, respectively, of the power-coupler mounting block 56.

As shown in FIG. 11B, the coaxial cable 22d of the HF generator 22 extends within the region 12a of the housing 12, underneath the surface 20h of the mounting block 20, through the through-hole 12k of the housing 12, and through the notch 56a of the power-coupler mounting block 56, and is electrically coupled to the above-described antenna of the cylindrical portion 28c of the power coupler 28.

The remaining components of the lighting fixture 54, and the couplings therebetween, are substantially identical to corresponding components of the lighting fixture 10, which are given the same reference numerals as noted above, and the couplings therebetween, and therefore will not be described in detail. As shown in FIGS. 11A and 11B, the lighting fixture 54 does not include components that are substantially similar to the power-coupler mounting plate 26 and the thermal pad 30 of the lighting fixture 10. In several exemplary embodiments, the installed condition of the lighting fixture 54 is substantially similar to the installed condition of the lighting fixture 10, and therefore will not be described in detail.

In operation, the lighting fixture 54 provides light to the environment surrounding the lighting fixture 54 in a manner substantially similar to the above-described manner in which the lighting fixture 10 provides light to the environment surrounding the lighting fixture 10, and therefore the provision of light by the lighting fixture 54 will not be described in detail.

During the operation of the lighting fixture 54, the power coupler 28 dissipates power in the form of heat. The majority of this heat flows from the power coupler 28 to the environment surrounding the lighting fixture 54 via several thermal paths. One such thermal path first includes conductive heat transfer from the mounting flange 28a of the power coupler 28 to the power coupler mounting block 56. The heat then conducts and spreads through the power coupler mounting block 56, and further flows into the base wall 12b of the housing 12 via conductive heat transfer. The heat then conducts and spreads through the housing 12, and then flows into the environment surrounding the lighting fixture 54 via convective heat transfer from the housing 12, including from the fins 12h, the wall 12c, the wall 12g and/or any combination thereof.

Moreover, during the operation of the lighting fixture 54, the HF generator 22 also dissipates power in the form of heat. The majority of this heat flows from the HF generator 22 to the environment surrounding the lighting fixture 54 in a manner similar to the above-described manner in which heat flows from the HF generator 22 to the environment surrounding the lighting fixture 10. Therefore, the heat flow from the HF generator 22 of the lighting fixture 54, to the environment surrounding the lighting fixture 54, will not be described in detail.

As a result of the above-described heat-transfer mechanisms, heat flow and thermal paths, any heat flow from the power coupler 28 to the HF generator 22 is appreciably reduced, thereby minimizing any temperature increase in the HF generator 22 due to the power dissipation of the power coupler 28.

Experimental testing of the lighting fixture 54 was conducted, with the lighting fixture 54 operating in the above-described manner during the experimental testing.

During at least a portion of the experimental testing, experimental temperature data was recorded, during which the power consumption of the lighting fixture 54 was at least about 165+/−10% watts, that is, at least about 148.5 watts. The experimental temperature of the HF generator 22 was measured using a thermocouple at the point A on the housing 22a of the HF generator 22. The experimental temperature of the HF generator 22 was recorded at an ambient air temperature of 40 degrees C., with the ambient air referring to the temperature of the air in the environment surrounding the lighting fixture 10. During the experimental testing, the experimental temperature of the HF generator 22 was measured and recorded with the lighting fixture 10 mounted to the ceiling. During the experimental testing, the experimental temperature of the HF generator 22 was measured and recorded using the globe 18.

Under the above-described experimental conditions, the experimental temperature of the HF generator 22 was less than or equal to about 65+/−10% degrees C., that is, less than or equal to about 71.5 degrees C., at an ambient air temperature of about 40 degrees C. Thus, the experimental temperature rise above ambient of the HF generator 22, that is, the difference in temperature between the experimental temperature of the HF generator 22 and the ambient air temperature, was less than or equal to about 31.5 degrees C. This was an unexpected result.

In view of the above-described experimental results, safe end life of the HF generator 22 of the lighting fixture 54 is highly likely because the experimental temperature of the HF generator 22 of the lighting fixture 54 was less than 82 degrees C., the temperature above which safe end of life of the HF generator 22 cannot be assured. Using the above-described U.S. method, the above-described experimental results show that the lamp 36 of the lighting fixture 54 has an average life of about 100,000 hours. This was an unexpected result. Using the above-described European method, the above-described experimental results show that the lamp 36 of the lighting fixture 54 has an average life of about 60,000 hours. This was an unexpected result.

A lighting fixture has been described that includes a lamp; a power coupler coupled to the lamp; a high-frequency generator electrically coupled to the power coupler; a housing defining a region in which the high-frequency generator is disposed; a mounting block coupled to the housing and the high-frequency generator, the mounting block being adapted to receive heat from the high-frequency generator; and a device coupled to the power coupler and the housing, the device being adapted to receive heat from the power coupler. In an exemplary embodiment, the mounting block defines a first surface; and wherein the lighting fixture further comprises a first thermal pad disposed between the high-frequency generator and the first surface of the mounting block for providing a thermally-conductive interface between the high-frequency generator and the first surface of the mounting block. In an exemplary embodiment, the mounting block defines a second surface; and wherein the lighting fixture further comprises a second thermal pad disposed between the second surface of the mounting block and the housing for providing a thermally-conductive interface between the second surface of the mounting block and the housing. In an exemplary embodiment, the mounting block defines a third surface; and wherein the lighting fixture further comprises a third thermal pad disposed between the third surface of the mounting block and the housing for providing a thermally-conductive interface between the third surface of the mounting block and the housing. In an exemplary embodiment, the mounting block defines a fourth surface; and wherein the lighting fixture further comprises a fourth thermal pad disposed between the fourth surface of the mounting block and the housing for providing a thermally-conductive interface between the fourth surface of the mounting block and the housing. In an exemplary embodiment, the device comprises a mounting plate; wherein the power coupler comprises a flange to which the mounting plate is coupled; and wherein the lighting fixture further comprises a thermal pad disposed between the flange and the mounting plate for providing a thermally-conductive interface between the flange and the mounting plate. In an exemplary embodiment, the device comprises another mounting block; and wherein the power coupler comprises a flange to which the another mounting block is coupled. In an exemplary embodiment, the lighting fixture is adapted to consume at least about 165+/−10% watts of power during operation; wherein the lamp is adapted to provide at least about 12,000 initial lumens; and wherein the temperature rise above ambient of at least a portion of the high-frequency generator is less than about 32 degrees C. during the operation of the lighting fixture. In an exemplary embodiment, the lighting fixture is adapted to consume at least about 165+/−10% watts of power during operation; wherein the lamp is adapted to provide at least about 12,000 initial lumens; and wherein the lamp comprises an average life of at least about 100,000 hours with a 50% failure rate. In an exemplary embodiment, the housing comprises an overall height of less than or equal to about 6.5 inches; and an outer diameter of less than or equal to about 11.5 inches. In an exemplary embodiment, the lighting fixture comprises a globe coupled to the housing, the globe defining an outside surface; a cover coupled to the housing, the cover comprising an opening; and a vapor-tight seal disposed in the opening; wherein the lighting fixture is adapted to consume at least about 165+/−10% watts of power during operation; wherein the lamp is adapted to provide at least about 12,000 initial lumens; and wherein the temperature rise above ambient of the outside surface of the globe is less than or equal to about 60 degrees C. during the operation of the lighting fixture.

A lighting fixture has been described that includes a lamp; a power coupler coupled to the lamp, the power coupler comprising a flange; a high-frequency generator electrically coupled to the power coupler; a housing defining a region in which the high-frequency generator is disposed, a mounting block coupled to the housing and the high-frequency generator, the mounting block being adapted to receive heat from the high-frequency generator; and a mounting plate coupled to the flange and the housing, the mounting plate being adapted to receive heat from the power coupler; wherein the mounting block defines first, second, third and fourth surfaces; wherein the lighting fixture further comprises a first thermal pad disposed between the high-frequency generator and the first surface of the mounting block for providing a thermally-conductive interface between the high-frequency generator and the first surface of the mounting block; a second thermal pad disposed between the second surface of the mounting block and the housing for providing a thermally-conductive interface between the second surface of the mounting block and the housing; a third thermal pad disposed between the third surface of the mounting block and the housing for providing a thermally-conductive interface between the third surface of the mounting block and the housing; a fourth thermal pad disposed between the fourth surface of the mounting block and the housing for providing a thermally-conductive interface between the third surface of the mounting block and the housing; and a fifth thermal pad disposed between the flange and the mounting plate for providing a thermally-conductive interface between the flange and the mounting plate; wherein the lighting fixture is adapted to consume at least about 165+/−10% watts of power during operation; wherein the lamp is adapted to provide at least about 12,000 initial lumens; wherein the lamp comprises an average life of at least about 100,000 hours with a 50% failure rate; and wherein the temperature rise above ambient of at least a portion of the high-frequency generator is less than about 32 degrees C. during the operation of the lighting fixture.

A method has been described that includes consuming at least about 165+/−10% watts of power using a lighting fixture, the lighting fixture comprising a lamp; providing at least about 12,000 initial lumens using the lighting fixture; and providing the lamp with an average life of at least about 100,000 hours with a 50% failure rate. In an exemplary embodiment, the lighting fixture further comprises a power coupler coupled to the lamp, and a high-frequency generator electrically coupled to the power coupler; and wherein providing the lamp with an average life of at least about 100,000 hours with a 50% failure rate comprises maintaining the temperature rise above ambient of at least a portion of the high-frequency generator at less than about 32 degrees C. during consuming at least about 165+/−10% watts of power using the lighting fixture. In an exemplary embodiment, the lighting fixture further comprises a housing defining a region in which the high-frequency generator is disposed. In an exemplary embodiment, the housing comprises an overall height of less than or equal to about 6.5 inches; and an outer diameter of less than or equal to about 11.5 inches. In an exemplary embodiment, the lighting fixture further comprises a globe coupled to the housing, the globe defining an outside surface; and wherein the method further comprises generally preventing one or more gases from flowing between the region defined by the housing and the environment surrounding the housing; and maintaining the temperature rise above ambient of the outside surface of the globe at less than or equal to about 60 degrees C. during consuming at least about 165+/−10% watts of power using the lighting fixture.

A method has been described that includes consuming at least about 165+/−10% watts of power using a lighting fixture, the lighting fixture comprising a lamp; a power coupler coupled to the lamp; a high-frequency generator electrically coupled to the power coupler; a housing defining a region in which the high-frequency generator is disposed; and a globe coupled to the housing, the globe defining an outside surface; providing at least about 12,000 initial lumens using the lighting fixture; providing the lamp with an average life of at least about 100,000 hours with a 50% failure rate, comprising maintaining the temperature rise above ambient of at least a portion of the high-frequency generator at less than about 32 degrees C. during consuming at least about 165+/−10% watts of power using the lighting fixture; optionally generally preventing one or more gases from flowing between the region and the environment surrounding the housing; and when generally preventing the one or more gases from flowing between the region and the environment surrounding the housing, maintaining the temperature rise above ambient of the outside surface of the globe at less than or equal to about 60 degrees C. during consuming at least about 165+/−10% watts of power using the lighting fixture.

A system has been described that includes means for consuming at least about 165+/−10% watts of power using a lighting fixture, the lighting fixture comprising a lamp; means for providing at least about 12,000 initial lumens using the lighting fixture; and means for providing the lamp with an average life of at least about 100,000 hours with a 50% failure rate. In an exemplary embodiment, the lighting fixture further comprises a power coupler coupled to the lamp, and a high-frequency generator electrically coupled to the power coupler; and wherein means for providing the lamp with an average life of at least about 100,000 hours with a 50% failure rate comprises means for maintaining the temperature rise above ambient of at least a portion of the high-frequency generator at less than about 32 degrees C. during consuming at least about 165+/−10% watts of power using the lighting fixture. In an exemplary embodiment, the lighting fixture further comprises a housing defining a region in which the high-frequency generator is disposed. In an exemplary embodiment, the housing comprises an overall height of less than or equal to about 6.5 inches; and an outer diameter of less than or equal to about 11.5 inches. In an exemplary embodiment, the lighting fixture further comprises a globe coupled to the housing, the globe defining an outside surface; and wherein the system further comprises means for generally preventing one or more gases from flowing between the region defined by the housing and the environment surrounding the housing; and means for maintaining the temperature rise above ambient of the outside surface of the globe at less than or equal to about 60 degrees C. during consuming at least about 165+/−10% watts of power using the lighting fixture.

A system has been described that includes means for consuming at least about 165+/−10% wafts of power using a lighting fixture, the lighting fixture comprising a lamp; a power coupler coupled to the lamp; a high-frequency generator electrically coupled to the power coupler; a housing defining a region in which the high-frequency generator is disposed; and a globe coupled to the housing, the globe defining an outside surface; means for providing at least about 12,000 initial lumens using the lighting fixture; means for providing the lamp with an average life of at least about 100,000 hours with a 50% failure rate, comprising means for maintaining the temperature rise above ambient of at least a portion of the high-frequency generator at less than about 32 degrees C.; optionally means for generally preventing one or more gases from flowing between the region and the environment surrounding the housing; and when generally preventing the one or more gases from flowing between the region and the environment surrounding the housing, means for maintaining the temperature rise above ambient of the outside surface of the globe at less than or equal to about 60 degrees C. during consuming at least about 165+/−10% wafts of power using the lighting fixture.

A method has been described that includes consuming at least about 165+/−10% wafts of power using a lighting fixture, the lighting fixture comprising a housing defining a region; and a high-frequency generator disposed in the region; and maintaining the temperature rise above ambient of at least a portion of the high-frequency generator at less than about 32 degrees C. during consuming at least about 165+/−10% watts of power using the lighting fixture. In an exemplary embodiment, the lighting fixture further comprises a power coupler electrically coupled to the high-frequency generator; and a lamp coupled to the power coupler. In an exemplary embodiment, the lighting fixture further comprises a globe coupled to the housing, the globe defining an outside surface; and wherein the method further comprises generally preventing one or more gases from flowing between the region defined by the housing and the environment surrounding the housing; and maintaining the temperature rise above ambient of the outside surface of the globe at less than or equal to about 60 degrees C. during consuming at least about 165+/−10% watts of power using the lighting fixture. In an exemplary embodiment, the housing comprises an overall height of less than or equal to about 6.5 inches; and an outer diameter of less than or equal to about 11.5 inches.

A system has been described that includes means for consuming at least about 165+/−10% watts of power using a lighting fixture, the lighting fixture comprising a housing defining a region; and a high-frequency generator disposed in the region; and means for maintaining the temperature rise above ambient of at least a portion of the high-frequency generator at less than about 32 degrees C. during consuming at least about 165+/−10% watts of power using the lighting fixture. In an exemplary embodiment, the lighting fixture further comprises a power coupler electrically coupled to the high-frequency generator; and a lamp coupled to the power coupler. In an exemplary embodiment, the lighting fixture further comprises a globe coupled to the housing, the globe defining an outside surface; and wherein the system further comprises means for generally preventing one or more gases from flowing between the region defined by the housing and the environment surrounding the housing; and means for maintaining the temperature rise above ambient of the outside surface of the globe at less than or equal to about 60 degrees C. during consuming at least about 165+/−10% watts of power using the lighting fixture. In an exemplary embodiment, the housing comprises an overall height of less than or equal to about 6.5 inches; and an outer diameter of less than or equal to about 11.5 inches.

It is understood that variations may be made in the foregoing without departing from the scope of the disclosure. For example, instead of, or in addition to the above-described induction lighting system, the lamp 36 may provide light to the environment surrounding the lighting fixture 10 and/or 54 using one or more high-intensity-discharge (HID) lamps, one or more incandescent lamps, one or more fluorescent lamps, and/or any combination thereof. Also, other components may be added to the lighting fixture 10 and/or 54 such as, for example, one or more dome reflectors, one or more angle reflectors, one or more guards and/or one or more refractors. Further, the lighting fixture 10 and/or 54 may be installed in a wide variety of other settings, and in a wide variety of other manners such as, for example, being coupled to a support structure without mounting the lighting fixture 10 and/or 54 to an intermediate support bracket or structure. Still further, one or more additional lamps may be included in the lighting fixture 10 and/or 54.

Any spatial references such as, for example, “upper,” “lower,” “above,” “below,” “between,” “vertical,” “angular,” “upward,” “downward,” “side-to-side,” “left-to-right,” “right-to-left,” “top-to-bottom,” “bottom-to-top,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A lighting fixture comprising:
a lamp;
a power coupler coupled to the lamp;
a high-frequency generator electrically coupled to the power coupler;
a housing defining a region in which the high-frequency generator is disposed;
a mounting block coupled to the housing and the high-frequency generator, the mounting block being adapted to receive heat from the high-frequency generator; and
a device coupled to the power coupler and the housing, the device being adapted to receive heat from the power coupler.

2. A lighting fixture comprising:
a lamp;
a power coupler coupled to the lamp, the power coupler comprising a flange;
a high-frequency generator electrically coupled to the power coupler;
a housing defining a region in which the high-frequency generator is disposed, a mounting block coupled to the housing and the high-frequency generator, the mounting block being adapted to receive heat from the high-frequency generator; and
a mounting plate coupled to the flange and the housing, the mounting plate being adapted to receive heat from the power coupler;
wherein the mounting block defines first, second, third and fourth surfaces;
wherein the lighting fixture further comprises:
a first thermal pad disposed between the high-frequency generator and the first surface of the mounting block for providing a thermally-conductive interface between the high-frequency generator and the first surface of the mounting block;
a second thermal pad disposed between the second surface of the mounting block and the housing for providing a thermally-conductive interface between the second surface of the mounting block and the housing;
a third thermal pad disposed between the third surface of the mounting block and the housing for providing a thermally-conductive interface between the third surface of the mounting block and the housing;
a fourth thermal pad disposed between the fourth surface of the mounting block and the housing for providing a thermally-conductive interface between the third surface of the mounting block and the housing; and
a fifth thermal pad disposed between the flange and the mounting plate for providing a thermally-conductive interface between the flange and the mounting plate;
wherein the lighting fixture is adapted to consume at least about 165+/−10% watts of power during operation;
wherein the lamp is adapted to provide at least about 12,000 initial lumens;
wherein the lamp comprises an average life of at least about 100,000 hours with a 50% failure rate; and
wherein the temperature rise above ambient of at least a portion of the high-frequency generator is less than about 32 degrees C. during the operation of the lighting fixture.

3. A method comprising:
consuming at least about 165+/−10% watts of power using a lighting fixture, the lighting fixture comprising a lamp;
providing at least about 12,000 initial lumens using the lighting fixture; and
providing the lamp with an average life of at least about 100,000 hours with a 50% failure rate.

4. A method comprising:
consuming at least about 165+/−10% watts of power using a lighting fixture, the lighting fixture comprising:
a lamp;
a power coupler coupled to the lamp;
a high-frequency generator electrically coupled to the power coupler;
a housing defining a region in which the high-frequency generator is disposed; and
a globe coupled to the housing, the globe defining an outside surface;
providing at least about 12,000 initial lumens using the lighting fixture;
providing the lamp with an average life of at least about 100,000 hours with a 50% failure rate, comprising:
maintaining the temperature rise above ambient of at least a portion of the high-frequency generator at less than about 32 degrees C. during consuming at least about 165+/−10% watts of power using the lighting fixture;
optionally generally preventing one or more gases from flowing between the region and the environment surrounding the housing; and
when generally preventing the one or more gases from flowing between the region and the environment surrounding the housing, maintaining the temperature rise above ambient of the outside surface of the globe at less than or equal to about 60 degrees C. during consuming at least about 165+/−10% watts of power using the lighting fixture.

5. A system comprising:
means for consuming at least about 165+/−10% watts of power using a lighting fixture, the lighting fixture comprising a lamp;
means for providing at least about 12,000 initial lumens using the lighting fixture; and
means for providing the lamp with an average life of at least about 100,000 hours with a 50% failure rate.

6. A system comprising:
means for consuming at least about 165+/−10% watts of power using a lighting fixture, the lighting fixture comprising:
a lamp;
a power coupler coupled to the lamp;
a high-frequency generator electrically coupled to the power coupler;
a housing defining a region in which the high-frequency generator is disposed; and
a globe coupled to the housing, the globe defining an outside surface;
means for providing at least about 12,000 initial lumens using the lighting fixture;
means for providing the lamp with an average life of at least about 100,000 hours with a 50% failure rate, comprising:
means for maintaining the temperature rise above ambient of at least a portion of the high-frequency generator at less than about 32 degrees C.;
optionally means for generally preventing one or more gases from flowing between the region and the environment surrounding the housing; and
when generally preventing the one or more gases from flowing between the region and the environment surrounding the housing, means for maintaining the temperature rise above ambient of the outside surface of the globe at less than or equal to about 60 degrees C. during consuming at least about 165+/−10% watts of power using the lighting fixture.

7. A method comprising:
consuming at least about 165+/−10% watts of power using a lighting fixture, the lighting fixture comprising:
a housing defining a region; and
a high-frequency generator disposed in the region; and
maintaining the temperature rise above ambient of at least a portion of the high-frequency generator at less than about 32 degrees C. during consuming at least about 165+/−10% watts of power using the lighting fixture.

8. A system comprising:
means for consuming at least about 165+/−10% watts of power using a lighting fixture, the lighting fixture comprising:
a housing defining a region; and
a high-frequency generator disposed in the region; and
means for maintaining the temperature rise above ambient of at least a portion of the high-frequency generator at less than about 32 degrees C. during consuming at least about 165+/−10% watts of power using the lighting fixture.
